(19) United States
(12) Patent Application Publication
(10) Pub. No.: US 2026/0309104 A1
(43) Pub. Date: Oct. 8, 2026

(54) PISTON AND INTERNAL COMBUSTION ENGINE

(71) Applicant: MAHLE International GmbH, Stuttgart (DE)

(72) Inventor: Petru Berghian, Livonia, MI (US)

(21) Appl. No.: 19/173,533

(22) Filed: Apr. 8, 2025

(51) Int. Cl. F02F 5/00; F16J 1/08

(52) U.S. Cl. CPC F02F 5/00; F16J 1/08

(57) ABSTRACT

A piston, for an internal combustion engine, includes a ring groove. The piston further includes a lower compression ring, an oil control ring, and a tensioning device. The lower compression ring, the oil control ring, and the tensioning device are arranged in the ring groove. The tensioning device prestresses the oil control ring against a first groove wall and the lower compression ring away from the first groove wall.

### TECHNICAL FIELD

The present invention relates to a piston for an internal combustion engine with a ring groove. The invention also relates to an internal combustion engine with such a piston.

### BACKGROUND

In internal combustion engines, pistons are used in a known manner, which are in contact with a cylinder wall via piston rings. The piston rings serve to seal a space between the piston and the cylinder wall, whereby an undesired blow-by flow that reduces the performance of the internal combustion engine is at least to be reduced. In order to reduce blow-by in particular, a conventional piston usually has three ring grooves, in which two compression rings and an oil control ring are arranged.

### SUMMARY

However, the disadvantage of such pistons with three ring grooves is that they are comparatively complex and therefore expensive to manufacture.

The present invention therefore deals with the problem of specifying a piston for an internal combustion engine, by means of which the disadvantages known from the prior art can at least be reduced.

This problem is solved by the subject matter of the independent claims according to the invention. Advantageous embodiments are the subject of the dependent claims.

The present invention is based on the general idea of combining a compression ring, an oil control ring and a tensioning device in a common ring groove, thereby reducing the two ring grooves previously required for the arrangement of the oil control ring and the compression ring to just a single ring groove, which makes it possible to manufacture the piston more cost-effectively overall. The piston for an internal combustion engine according to the invention has at least one ring groove in which a lower compression ring, an oil control ring and a tensioning device arranged in between are arranged, this tensioning device tensioning the oil control ring against a first groove wall and the lower compression ring away from it, in particular against an opposite second groove wall. The arrangement of the lower compression ring, the oil control ring and the tensioning device arranged in between can significantly reduce the complexity of the piston, since only two ring grooves or even just a single ring groove are required, and not three ring grooves as has been the case up to now, in particular if an upper compression ring is also arranged in the ring groove. At the same time, the arrangement of the oil control ring and the lower compression ring in a common ring groove can ensure a faster return of oil to the interior of the piston.

In a favorable further development of the piston according to the invention, an oil drain opening is provided at a groove base of the ring groove. Via such an oil drain opening, oil can be returned to a crankcase of the internal combustion engine, whereby more oil is available for the actual lubrication.

In a favorable further development of the piston according to the invention, the lower compression ring has a first shoulder with which it engages in the tensioning device. The tensioning device itself has a second shoulder that interacts with the first shoulder of the lower compression ring. The tensioning device can exert both an axial force and a radial force, relative to a piston axis, on the lower compression ring, which offers the great advantage that axial play between the lower compression ring and a groove wall of the ring groove can be reduced to a minimum or even eliminated. This can improve in particular the wiping ability and gas tightness of the lower compression ring.

The tensioning device advantageously has a third shoulder that interacts with the oil control ring. The third shoulder can be used to prestress the oil control ring in the outward radial direction against a cylinder wall, thereby achieving reliable oil scraping and thus reliable oil return.

It is useful for the tensioning device to pretension the lower compression ring against a second groove wall opposite the first groove wall, wherein this second groove wall extends obliquely to a radial direction of the piston in such a way that the ring groove widens outwards. By means of this type of outwardly widening ring groove, the tensioning device can be used to bias the lower compression ring outwards against the cylinder wall, where, during operation of the internal combustion engine, a blow-by flow is at least reduced. In particular, the efficiency of the internal combustion engine can be significantly increased by reducing the blow-by flow.

In a further advantageous embodiment of the piston according to the invention, an upper compression ring is provided, wherein a recess is arranged in a groove base, in which the lower compression ring engages. The recess is about 1.5 mm deeper in the radial direction than a groove base diameter, wherein the lower compression ring can engage about 1 mm deep into the recess. This fixes it in the axial direction so that its axial play can be minimized or reduced. In this case, only a single ring groove is required in which the lower and upper compression rings, the oil control ring and the tensioning device can be arranged.

The present invention is also based on the general idea of equipping an internal combustion engine with a piston as described in the previous paragraphs, whereby the advantages listed with regard to the piston according to the invention can also be transferred to the internal combustion engine according to the invention. Specifically, these advantages lie in particular in a significantly reduced complexity of the piston, whereby the piston and indirectly the internal combustion engine can be produced more cost-effectively. The elimination of the third ring groove also allows a piston that is more compact in terms of its height to be achieved, and thus an internal combustion engine that is more compact in terms of its height, which is particularly advantageous in the cramped engine compartments of modern motor vehicles.

In a particularly preferred embodiment of the internal combustion engine according to the invention, it is designed as a hydrogen internal combustion engine. The oil control ring, compression ring and the tensioning device, which are also arranged in a common ring groove, allow the oil used to lubricate the piston to run longer on a cylinder wall, thereby minimizing wear, in particular on an upper compression ring, which can occur, for example, due to the dry properties of hydrogen. The piston according to the invention is thus particularly suitable for an internal combustion engine designed as a hydrogen combustion engine.

In general, the internal combustion engine according to the invention can be designed not only as a hydrogen internal combustion engine, a gasoline engine or a diesel engine, but can also use other ignitable fuels.

Further important features and advantages of the invention can be seen in the sub-claims, in the drawings and in the associated description of the figures on the basis of the drawings.

It is understood that the features mentioned above and those to be explained below can be used not only in the combination given in each case, but also in other combinations or on their own, without leaving the scope of the invention as defined by the claims. The above-mentioned and subsequently mentioned components of a higher-level unit, such as a device, an apparatus or an arrangement, which are designated separately, can form separate parts or components of this unit or be integral areas or sections of this unit, even if this is shown differently in the drawings.

Preferred embodiments of the invention are shown in the drawings and are explained in more detail in the following description, where the same reference signs refer to the same or similar or functionally identical components.

### BRIEF DESCRIPTION OF THE DRAWINGS

The following show, in each case schematically:

FIG. 1 shows a cross-sectional view of a piston of an internal combustion engine according to the invention;

FIG. 2 shows a representation as in FIG. 1, but with an asymmetrical tensioning device; and

FIG. 3 shows a further possible embodiment of a piston according to the invention, with a lower compression ring, an upper compression ring, an oil control ring and a tensioning device arranged in a common ring groove.

### DETAILED DESCRIPTION

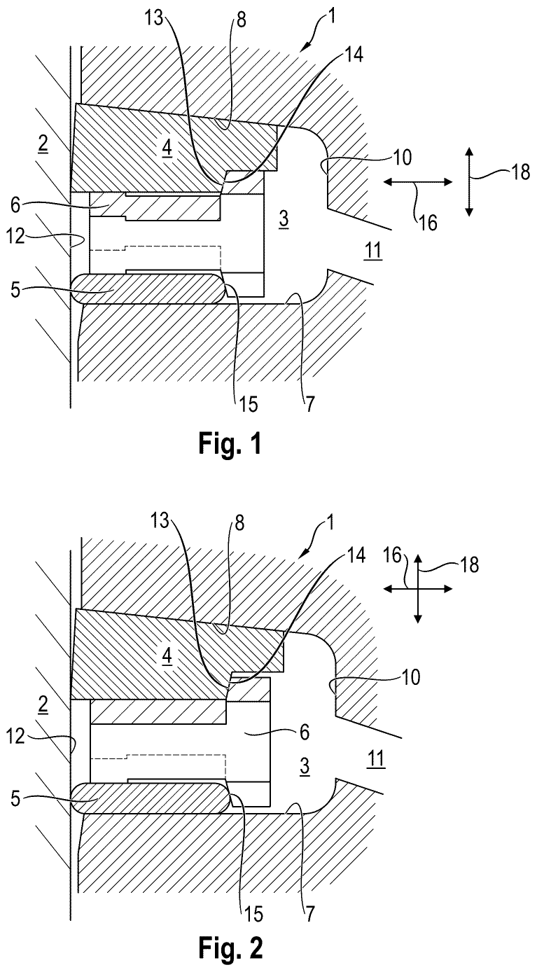

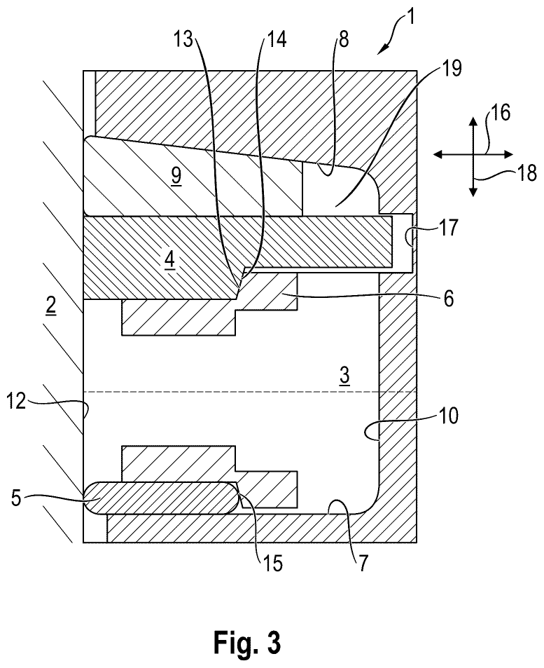

In accordance with FIGS. 1 to 3, a piston 1 of an internal combustion engine 2, which is also in accordance with the invention, has a ring groove 3, in which a lower compression ring 4, an oil control ring 5 and a tensioning device 6 are arranged. The tensioning device 6 is arranged between the lower compression ring 4 and the oil control ring 5 and tensions the oil control 5 against a first groove wall 7. The tensioning device 6 can, for example, have a coil spring that is not shown. At the same time, the device 6 provides tensions to the lower compression ring 4 against either a second groove wall 8 lying opposite the first groove wall 7 (compare FIGS. 1 and 2), or against an upper compression ring 9 (compare FIG. 3).

By arranging at least the lower compression ring 4, the tensioning device 6 and the oil control ring 5 in a common ring groove 3, the number of ring grooves of the piston 1 can be reduced from three to two, since the lower compression ring 4 and the oil control ring 5 are no longer arranged in two separate ring grooves, as has been the case up to now. By eliminating one of these ring grooves and combining at least the lower compression ring 4, the tensioning device 6 and the oil control ring 5 in a common ring groove 3, the piston 1 according to the invention can be manufactured much more easily and thus also more cost-effectively. In FIGS. 1 and 2, a second, not shown, ring groove with an upper compression ring would thus still be provided.

This can be further improved by the fact that the upper compression ring 9 is also arranged in the ring groove 3, so that in the best case only a single annular/ring groove 3 per piston 1 is to be provided, as shown in FIG. 3.

If one looks at the ring groove 3 more closely, one can see that an oil discharge opening 11 is provided at a groove base 10 of the same. Via this oil discharge opening 11, oil scraped off by the oil control 5 from a cylinder wall 12 can be fed back to an unspecified crankcase. An oil drain hole 11 of this kind is, of course, also provided in the piston 1, as shown in FIG. 3, but in this case it is located outside the sectional plane and is therefore not visible.

If you take a closer look at the lower compression ring 4, you can see that the lower compression ring 4 has a first shoulder 13, which engages with the tensioning device 6. The tensioning device 6 has a second shoulder 14, which works together with the first shoulder 13 of the lower compression ring 4. The inclination of the first shoulder 13 and of the second shoulder 14 is aligned in such a way that, when the tensioning device 6 is clamped, the lower compression ring 4 is pressed against the cylinder wall 12 of the internal combustion engine 2 and a gap existing between the piston 1 and the cylinder wall 12 is sealed as well as possible. By sealing the gap between the cylinder wall 12 and the piston 1, undesired blow-by flows can at least be reduced, and preferably almost completely eliminated, whereby the efficiency of the internal combustion engine 2 according to the invention can be significantly increased.

The tensioning device 6 also has a third shoulder 15, which interacts with the oil control ring 5 and also presses it against the cylinder wall 12 of the internal combustion engine 2 during tensioning.

If you look at the second groove wall 8, you can see that the second groove wall 8 runs at an angle to a radial direction 16 of the piston 1, so that the ring groove 3 widens radially outwards, i.e. in the direction from the groove base 10 to the cylinder wall 12.

This has the advantage that the lower compression ring 4, which is pressed against the second groove wall 8 by means of the tensioning device 6, is at the same time prestressed in the direction of the cylinder wall 12, i.e. radially outwards. The prestressing against the cylinder wall 12 can preferably seal the gap present between the piston 1 and the cylinder wall 12, whereby a blow-by flow occurring there during the operation of the internal combustion engine 2 can preferably be avoided and the efficiency of the internal combustion engine 2 can be increased as a result.

If one looks again at the piston 1 as shown in FIG. 3, one can see that a recess 17 is arranged at a groove base 10 of the ring groove 3, in which recess the lower compression ring 4 engages. The recess 17 is about 1.5 mm deep, so that the lower compression ring 4 can engage about 1 mm into the recess 17.

This minimizes or reduces axial movement of the lower compression ring 4 in axial direction 18. The piston 1 according to the invention can be used in diesel internal combustion engines or in hydrogen internal combustion engines. The piston 1 is preferably designed as a steel piston. In particular, in hydrogen internal combustion engines, the resulting blow-by is still acceptable, while a reverse blow-by can be reduced even further than in conventional passenger car engines.

In general, the internal combustion engine 2 according to the invention can be designed not only as a hydrogen internal combustion engine, a gasoline engine or a diesel engine, but can also use other ignitable fuels. This means that the piston 1 according to the invention can be used in all possible internal combustion engines 2.

In FIG. 3 an asymmetrical tensioning device 6 is shown, while in FIGS. 1 and 2 a symmetrical tensioning device 6 is shown. Both is possible.

The advantage of the upper compression ring 9 arranged in the ring groove 3, according to FIG. 3, is also that blow-by gas can enter a space 19 behind the upper compression ring 9 and then press it outwards against the cylinder wall 12, thereby increasing the sealing effect.

With the piston 1 according to the invention, its production can be significantly simplified and thus made more cost-effective due to a reduction of the ring grooves 3 from three to two or only a single one, since in the piston 1 according to the invention at least the oil control ring 5, the lower compression ring 4 and the tensioning device 6 are arranged in a common ring groove 3. A ring groove that was previously separately dedicated for the oil control ring 5 can thus be dispensed with. The lower compression ring 4, the tensioning device 6 and the oil control ring 5 can be assembled in the ring groove 3, for example by using a conical sleeve in combination with a temporary holding band.

The specification can be best understood with reference to the following Numbered Paragraphs:

Numbered Paragraph 1: A piston (1) for an internal combustion engine (2) with a ring groove (3), in which a lower compression ring (4), an oil control ring (5), and a tensioning device (6) are arranged, the tensioning device (6) prestressing the oil control ring (5) against a first groove wall (7) and the lower compression ring (4) away from it.

Numbered Paragraph 2: The piston (1) of Numbered Paragraph 1, characterized in that an oil discharge opening (11) is provided at a groove base (10).

Numbered Paragraph 3: The piston (1) of Numbered Paragraph 1 or Number Paragraph 2, characterized in that the lower compression ring (4) has a first shoulder (13) by means of which it engages in the tensioning device (6).

Numbered Paragraph 4: The piston (1) of Numbered Paragraph 3, characterized in that the tensioning device (6) has a second shoulder (14) which interacts with the first shoulder (13) of the lower compression ring (4).

Numbered Paragraph 5: The piston (1) of one of preceeding Numbered Paragraphs, characterized in that the tensioning device (6) has a third shoulder (15) which interacts with the oil control ring (5).

Numbered Paragraph 6: The piston (1) of one of preceeding Numbered Paragraphs, characterized in that the tensioning device (6) prestresses the lower compression ring (4) against a second groove wall (8) located opposite the first groove wall (7).

Numbered Paragraph 7: The piston (1) of Numbered Paragraph 6, characterized in that the second groove wall (8) extends obliquely with respect to a radial direction (16) of the piston (1) in such a way that the ring groove (3) widens outwards.

Numbered Paragraph 8: The piston (1) of one of Numbered Paragraphs 2 to 5, characterized in that an upper compression ring (9) is provided, in that a recess (17) is arranged in a groove base (10), in which recess the lower compression ring (4) engages.

Numbered Paragraph 9: An internal combustion engine (2) having a piston (1) according to one of the preceding paragraphs.

Numbered Paragraph 10: The internal combustion engine (2) of Numbered Paragraph 9, characterized in that the internal combustion engine (2) is designed as a hydrogen internal combustion engine, a gasoline engine or a diesel engine.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, ”in examples,“ ”with examples,“ ”various embodiments,“ ”with embodiments,“ ”in embodiments,“ or ”an embodiment,“ or the like, means that a particular feature, structure, or characteristic described in connection with the example/embodiment is included in at least one embodiment. Thus, appearances of the phrases ”examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context.

Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. All matter contained in the above description or shown in the accompanying drawings shall be interpreted as illustrative only and not limiting. Changes in detail or structure may be made without departing from the present disclosure.

1. A piston for an internal combustion engine, the piston comprising:
a ring groove that axially widens in a radially outward direction;
a lower compression ring;
an oil control ring; and
a tensioner;
wherein the lower compression ring, the oil control ring, and the tensioner are arranged in the ring groove; and
wherein the tensioner prestresses the oil control ring against a first groove wall and the lower compression ring away from the first groove wall.

2. The piston according to claim 1, further comprising an oil discharge opening at a groove base.

3. The piston according to claim 1, wherein the lower compression ring has a first shoulder configured to engage with the tensioner.

4. The piston according to claim 3, wherein the tensioner has a second shoulder configured to interact with the first shoulder of the lower compression ring.

5. The piston according to claim 1, wherein the tensioner has a shoulder configured to interact with the oil control ring.

6. The piston according to claim 1, wherein the tensioner prestresses the lower compression ring against a second groove wall located opposite the first groove wall.

7. The piston according to claim 6, wherein the second groove wall extends obliquely with respect to a radial direction of the piston.

8. The piston according to claim 2, further comprising:
an upper compression ring arranged in the ring groove; and
a recess arranged in a groove base;
wherein the lower compression ring engages with the recess.

9. An internal combustion engine, comprising:
a piston including:
a piston body including a ring groove that axially widens in a radially outward direction;
a lower compression ring;
an oil control ring; and
tensioner;
wherein the lower compression ring, the oil control ring, and the tensioner are arranged in the ring groove; and
wherein the tensioner prestresses the oil control ring against a first groove wall and the lower compression ring away from the first groove wall.

10. (canceled)

11. The internal combustion engine according to claim 9, wherein:
the lower compression ring has a first shoulder engaged with the tensioner;
the tensioner includes an upper shoulder engaged with the lower compression ring; and/or
the tensioner includes a lower shoulder engaged with the oil control ring.

12.-13. (canceled)

14. The internal combustion engine according to claim 9, wherein the tensioner prestresses the lower compression ring against a second groove wall located opposite the first groove wall.

15. The internal combustion engine according to claim 14, wherein the second groove wall extends obliquely with respect to a radial direction of the piston.

16. The internal combustion engine according to claim 9, further comprising:
an upper compression ring arranged in the ring groove; and
a recess arranged in a groove base;
wherein the lower compression ring engages with the recess.

17. The internal combustion engine according to claim 9, wherein the internal combustion engine is a hydrogen internal combustion engine, a gasoline engine or a diesel engine.

18.-20. (canceled)

21. A piston for an internal combustion engine, comprising:
a piston body including:
a first groove wall;
a second groove wall;
a radially outward facing groove base wall extending from the first groove wall to the second groove wall;
a ring groove defined by the first groove wall, the second groove wall, and the groove base wall; and
a recess disposed in the groove base wall and projecting radially into the piston body;
a lower compression ring arranged in the ring groove and projecting radially into the recess;
an upper compression ring arranged in the ring groove axially between the lower compression ring and the second groove wall of the piston body;
an oil control ring arranged in the ring groove adjacent to the first groove wall; and
a tensioner arranged in the ring groove axially between the lower compression ring and the oil control ring, the tensioner pressing the oil control ring toward the first groove wall and pressing the lower compression ring toward the second groove wall;
wherein the upper compression ring is radially aligned with a portion of the groove base wall that adjoins the second groove wall.

22. The piston according to claim 21, wherein a space into which blow-by gas is flowable is formed in the ring groove radially inward of the upper compression ring.

23. The piston according to claim 22, wherein the space is defined by the upper compression ring, the second groove wall, the groove base wall, and the lower compression ring.

24. The piston according to claim 21, wherein:
the piston body further includes:
a first recess wall;
a second recess wall; and
a radially outward facing recess base wall extending from the first recess wall to the second recess wall;
the recess is defined by the first recess wall, the second recess wall, and the recess base wall; and
the lower compression ring is disposed spaced apart from the first recess wall, the second recess wall, and the recess base wall when the upper compression ring is engaged with the second groove wall and with a cylinder wall.

25. The piston according to claim 21, wherein the tensioner is symmetrical relative to an imaginary plane that is oriented perpendicular to a central axis of the piston body and that bisects the tensioner.

26. The piston according to claim 21, wherein the second groove wall extends obliquely relative to the first groove wall such that the ring groove axially widens in a radially outward direction.
